(19) United States
(12) Patent Application Publication
(10) Pub. No.: US 2007/0154287 A1
(43) Pub. Date: Jul. 5, 2007

(54) Installation element

(75) Inventor: Linger Lin, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/395,070

(22) Filed: Mar. 30, 2006

(30) Foreign Application Priority Data
Dec. 30, 2005 (TW) 94223085

(51) Int. Cl. F16B 37/00

(52) U.S. Cl. 411/427

(57) ABSTRACT

An installation element is proposed, which includes a body, a coupling portion, an installation hole, and a coupling hole. The body includes a first surface and an opposing second surface. The coupling portion extends outward from the first surface. The installation hole and the coupling hole, whose axes are parallel, are installed in the body. The installation hole penetrates the body, whereas the coupling hole penetrates both the body and the coupling portion. The coupling portion may be positioned on a board having a positioning opening, such that the coupling portion positionally corresponds to the positioning opening. The board further includes an installation opening connected and aligned with the installation hole, such that not only is the installation element fixed on the board by a coupling element which penetrates both the installation opening and the installation hole, but another board is fixed to the installation element by the coupling hole.

### BACKGROUND OF THE INVENTION

1. Field of the Invention

The present invention relates to an installation element, and more particularly, to an installation element for fixing two boards in position.

2. Description of Related Art

Since their birth, circuit boards for holding integrated circuits have been widely used in various electronic devices. A circuit board which serves as the main board of an electronic device is typically fixed on a board having an installation function. However, there must be a gap between the circuit board and the board for the sake of heat dissipation and prevention of short circuits. To achieve the aforesaid objective, bumps are disposed on the board, and, alternatively, an installation element is installed on the board so as to fix the circuit board on the board.

As regards a servo device, it is secured on a carrier board locked to a main board. Since the main board usually holds important components installed thereon, such as a CPU, the carrier board must be made of tensile tough metal. However, a metallic carrier board tends to bring short circuits to the circuits on the main board. Hence, it is necessary to use an appropriate element to space the main board and the carrier board apart before locking them.

FIGS. 1A and 1B are schematic views of a conventional fixing pillar for installing a main board on a carrier board. As shown in FIG. 1A, the fixing pillar 1 comprises a hollow body 10. The body 10 is hexagonal-shaped so as to facilitate manual screwing. A threaded hole 11 is disposed inside the body 10, whereas an opening 12 is disposed at the top of the body 10. A bolt 13 protrudes out of the base of the body 10.

As shown in FIG. 1B, the fixing pillar 1 is installed on a carrier board (a computer backboard) 14 and serves to secure the main board 15 in position. The bolt 13 of the fixing pillar 1 is screwed into a threaded hole 140 in the carrier board 14. Also, the bolt 13 is centered on an opening 150 which penetrates the main board 15. A bolt 16 is screwed into the threaded hole 11 via the opening 150, so as to secure the main board 15 in place. In so doing, the body 10 separates the main board 15 from the carrier board 14.

Admittedly, a conventional fixing pillar can separate a main board from a carrier board so as to free the main board from short circuits. However, as shown in FIG. 1B clearly, the bolt 13 does penetrate the threaded hole 140, because the carrier board 14 is so thin that the number of threads the threaded hole 140 provides for the bolt 13 for the purpose of locking is quite limited. If the number of threads of the bolt 13 equaled that of the threaded hole 140, the bolt 13 was quite likely to withdraw from the threaded hole 140. It is because the fixing pillar 1 tends to rotate along with the bolt 16 whenever a user is unscrewing the bolt 16 with a view to dismounting the main board from the servo device.

A fixing pillar with a bolt projecting from an upstanding carrier board of a PC is tolerable. By contrast, this is not the case, when it comes to a servo device, because a carrier board functions as a backboard, as far as a servo device is concerned.

Even if the bolt 13 of a conventional fixing pillar 1 was elongated with a view to preventing the fixing pillar 1 from being disconnected from the carrier board 14, the main board would seldom be firmly secured in place, because the main board and the carrier board are coaxially locked together and thus they get loosened readily during installation/uninstallation or under vibration.

Considering the need to firmly secure a main board in place, the threaded hole 11 should be provided with adequate threads for locking the bolt 16. As a result, the body 10 must be long enough to possess sufficient threads. However, when it comes to a servo device of limited height, such as a thin server, the aforesaid solution has its limitation, that is, it ends up with an excessively raised main board with little space for manipulation.

The aforesaid problems, namely simultaneous rotation of a screw and a fixing pillar, insufficient threads, and limited space for manipulation, are not unique to a servo device, but common in whatever devices have two boards installed side by side and a gap maintained therebetween.

Therefore, the problem to be solved here is to develop and fabricate a novel component for being installed on a board so as to secure another board in place and overcome the drawbacks of the foregoing prior art.

### SUMMARY OF THE INVENTION

In light of the drawbacks of the foregoing prior art, it is a primary objective of the present invention to provide an installation element comprising at least two self-contained holes which are free of any operation-related simultaneous movement.

Another objective of the present invention is to provide an installation element short enough to occupy less space.

Yet another objective of the present invention is to provide an installation element for firmly fixing two boards in position and maintaining a gap therebetween.

In order to achieve the above and other objectives, the present invention discloses an installation element comprising a body, a coupling portion, an installation hole, and a coupling hole. The body comprises a first surface and an opposing second surface. The coupling portion extends outward from the first surface. The installation hole and the coupling hole, whose axes are parallel, are installed in the body. The installation hole penetrates the body, whereas the coupling hole penetrates both the body and the coupling portion. The coupling portion may be positioned on a board having a positioning opening, such that the coupling portion positionally corresponds to the positioning opening. The board further comprises an installation opening connected and aligned with the installation hole, such that not only is the installation element fixed on the board by a coupling element which penetrates both the installation opening and the installation hole, but another board is fixed to the installation element by the coupling hole.

In an embodiment, for instance, the board serves as a carrier board of a servo device and a countersink bolt as the coupling element, a conical-shaped hole as the installation opening, and a threaded hole as the installation hole; also, the installation hole and the installation opening match and have the same caliber. The coupling portion is a protruding, polygonal-shaped block. The coupling portion is positioned in the positioning opening, such that the installation hole is placed in a position whereby the installation hole is connected and aligned with the installation opening. The coupling hole is a threaded hole connected and aligned with the positioning opening.

The other board may be, for example, a main board of the servo device, and comprises an opening. The opening is inserted with a bolt which matches the coupling hole, such that the bolt is inserted into the coupling hole via the opening, thus fixing the main board to the installation element.

In order to fix a main board on a carrier board of limited thickness in a servo device, the bolt of a fixing pillar inevitably projects out of the carrier board according to the prior art. By contrast, the installation element of the present invention is fixed on the carrier board, using a countersink bolt which is screwed into the carrier board from below the carrier board and penetrates the installation opening (a conical-shaped hole) disposed in the carrier and then the installation hole (a threaded hole) disposed in the installation element; the head of the countersink bolt lies flush with the surface of the carrier board after the countersink bolt is driven into the conical-shaped hole. Hence, the present invention has the following advantages.

First, no bolt protrudes out of the carrier board, thus ease of use is enhanced. Second, the threaded holes disposed in the installation element provide more threads than the carrier board does for a locking purpose, thus the installation element is firmly fixed on the carrier board. Thirdly, the coupling hole for fixing the main board in place and the installation hole for fixing the carrier board in place are not coaxially disposed, thus solving a drawback of the prior art, that is, the fixing pillar gets loosened undesirably as a result of a user's turning a bolt configured to fix the main board in place. And further, rotation of the coupling portion in the positioning opening is restricted because of the profile of the positioning opening and that of the coupling portion; hence, after the coupling portion is positioned in the positioning opening, the installation hole is placed in a position whereby the installation hole is connected and aligned with the installation opening.

Considering the need to firmly secure a main board in place, a conventional fixing pillar must be of a minimal length, and in consequence the conventional fixing pillar brings about a waste of space when applied in a thin servo device. By contrast, in the present invention, the bolt configured to fix a main board in place penetrates the coupling portion, and the coupling portion looks like a protruding block, which means that the number of threads provided is increased because of the coupling portion; however, the coupling portion is embedded in the carrier board, thus the coupling portion does not widen the gap between the carrier board and the main board at all and waste the internal space available.

Accordingly, the installation element of the present invention is positioning sensitive, space-saving, and secure and thereby fit to overcome the drawbacks of the prior arts and is highly industrial applicable.

### BRIEF DESCRIPTION OF DRAWINGS

The present invention can be more fully understood by reading the following detailed description of the preferred embodiment, with reference made to the accompanying drawings, wherein:

FIGS. 1A and 1B show a schematic view of a conventional fixing pillar for fixing a main board in place and raising the main board;

FIGS. 2A and 2B show a schematic view of a preferred embodiment of an installation element of the present invention;

FIG. 3 shows a lateral, exploded, sectional view of the installation element fixed in a carrier board according to the present invention;

FIG. 4 shows a lateral, exploded, sectional view of the installation element fixed in the carrier board and connected to another board according to the present invention; and

FIGS. 5A and 5B show a schematic view of another embodiment of the installation element of the present invention.

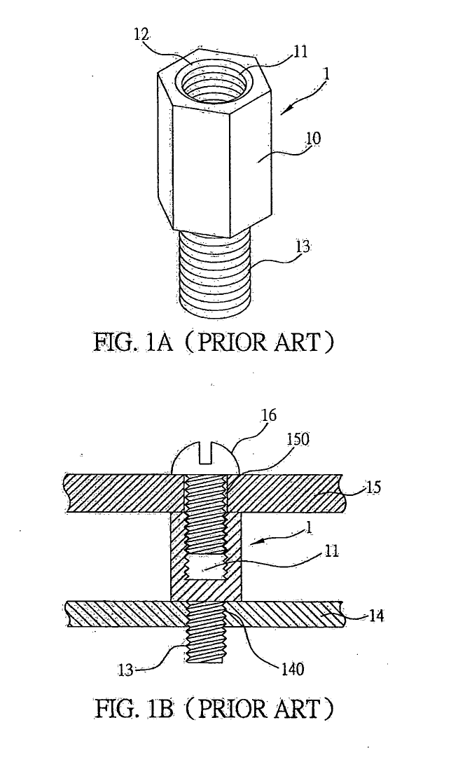

### DETAILED DESCRIPTION OF PREFERRED EMBODIMENTS

The following specific embodiments are provided to illustrate the present invention. Others skilled in the art will readily understand other advantages and functions of the present invention in accordance with the contents disclosed in this specification. The present invention can also be performed or applied by other different embodiments. Various modifications and changes based on different viewpoints and applications can be made in the details of the specification without departing from the spirit of the present invention.

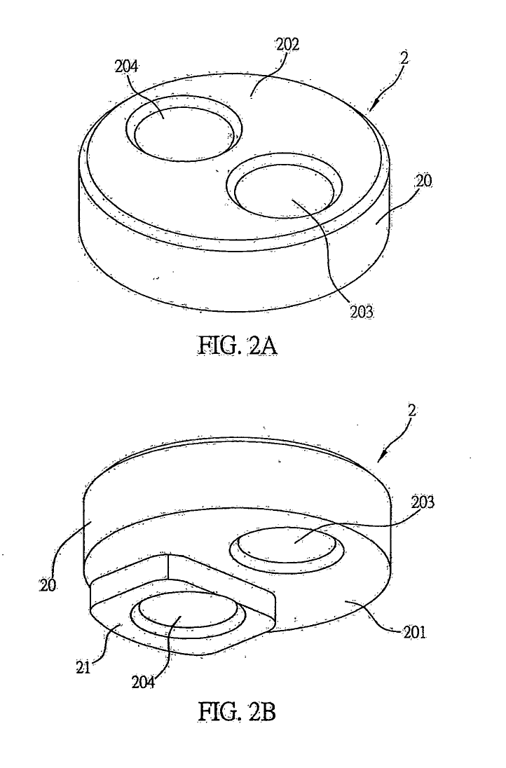

FIGS. 2 to 5 are diagrams drawn in light of a preferred embodiment of an installation element of the present invention. It should be noted that the installation element described in the following embodiment is applicable to any device having a board, such as a desktop PC, notebook computer, portable electronic product, and servo device. Although an installation element for fixing a main board on a carrier board of a servo device serves as an example of the embodiment described below, the scope of the present invention should not be limited thereto. Not only is the present invention applicable to any conventional devices, such as a desktop PC, notebook computer, and any other device equipped with a board, but an applicable device is seldom structurally changed, thus the appended drawings only show whatever structure is directly related to the present invention, but omit the irrelevant part, with a view to describing the characteristics and structure of-the present invention in a simple, clear and understandable manner

FIGS. 2A and 2B show a schematic view of a preferred embodiment of an installation element of the present invention the present invention discloses an installation element 2 comprising a body 20, a coupling portion 21, an installation hole 203, and a coupling hole 204. The body 20 comprises a first surface 201 and an opposing second surface 202. The coupling portion 21 extends outward from the first surface 201. The installation hole 203 and the coupling hole 204, whose axes are parallel, are installed in the body 20. The installation hole 203 penetrates the body 20, whereas the coupling hole 204 penetrates both the body 20 and the coupling portion 21.

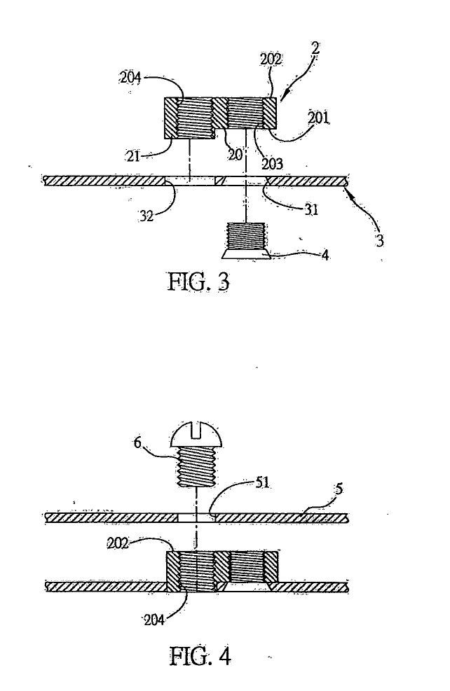

FIG. 3 shows a schematic view of the installation element 2 fixed in a board according to the present invention. An installation opening 31 and a positioning opening 32 are disposed in the board 3. The coupling portion 21 positionally corresponds to the positioning opening 32. The installation opening 31 is connected and aligned with the installation hole 203, such that not only is the installation element 2 fixed on the board 3 by a coupling element 4 which penetrates both the installation opening 31 and the installation hole 203, but another board is fixed to the installation element 2 by the coupling hole 204.

For instance, a countersink bolt serves as the coupling element 4, a conical hole as the installation opening 31, and a threaded hole as the installation hole 203. The installation hole 203 and the installation opening 31 share the same caliber so as to hold the countersink bolt, such that the installation element 2 is fixed to the board 3. The head of the countersink bolt lies flush with the surface of the board 3 after the countersink bolt is driven into the conical-shaped hole.

For instance, the coupling hole 204 may be a threaded hole connected and aligned with the positioning opening 32. The coupling hole 204 is configured to penetrate both the body 20 and the coupling portion 21 so as to provide relatively more threads. The coupling hole 204 and the installation hole 203 are not coaxially disposed, thus the body 20 can contain both the coupling hole 204 and the installation hole 203 though it is thin. The coupling portion 21 looks like a protruding block, which, coupled with the profile of the positioning opening 32, places the installation hole 203 at a position whereby the installation hole 203 is connected and aligned with the installation opening 31.

FIG. 4 shows a lateral, exploded, sectional view of the installation element 2 fixed in the board 3 and connected to another board 5 according to the present invention. Lying on the second surface 202 is the board 5 which can be a main board of a servo device, for example. The board 5 comprises an opening 51 connected and aligned with the coupling hole 204. A bolt 6, which matches the coupling hole 204, is screwed into the coupling hole 204 via the opening 51, so as to fix the board 5 to the installation element 2. As indicated by the above-mentioned, with the body 20 becoming thinner than before, the board 3 and the board 5 are drawn closer, thus preventing a waste of space inside the servo device.

It should be noted that implementation of coupling the installation hole 203 to the coupling element 4 and that of coupling the coupling hole 204 to the bolt 6 are not limited to this embodiment. For instance, each of the coupling element 4 and the bolt 6 may be replaced with a pillar having an elastic tenon, whereas each of the installation hole 203 and the coupling hole 204 may be replaced with a hole having a matching groove. The coupling of the aforesaid components can be implemented in many ways which belong to the related prior art, thus various modes of the aforesaid implementation require no verbosity herein. For this reason, only a preferred embodiment characterized by optimal coupling and a highly available locking structure is described herein.

The coupling portion 21 may have a rectangular or polygonal (non-circular) profile. The coupling portion 21 is positioned in the positioning opening 32. Owing to its aforesaid profile, the coupling portion 21 cannot be rotated after being positioned in the positioning opening 32, thereby placing the installation hole 203 in a position whereby the installation hole 203 is connected and aligned with the installation opening 31, for subsequent coupling. The installation element 2 with the aforesaid appearance is useful in holding a board with large area; in such a scenario, there is even distribution of stress, because the first and second surfaces 201 and 202 together greatly exceed the installation hole 203 and the coupling hole 204 together in area.

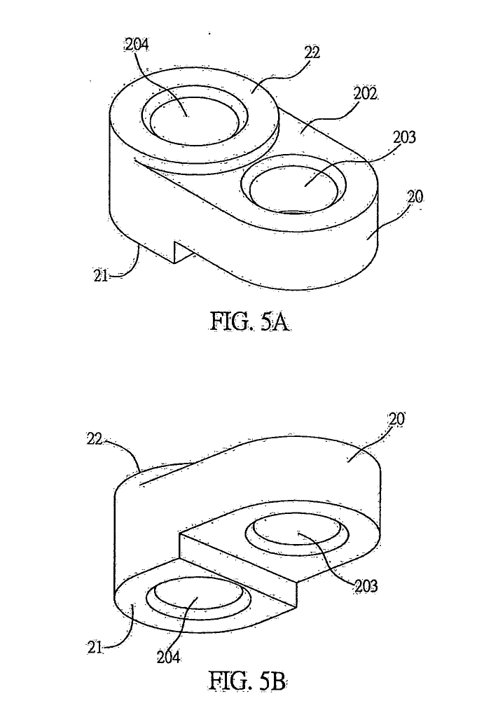

FIGS. 5A and 5B show a schematic view of another embodiment of the installation element of the present invention. The body 20 of the installation element is occupied by the installation hole 203 and the coupling hole 204 to a great extent, such that the first and second surfaces 201 and 202 together slightly exceed the installation hole 203 and the coupling hole 204 together in area. The installation element with the aforesaid appearance is useful in holding a board with small area; small contact area means space saving, such that components installed on the board are free from interference. In addition, an annular portion 22 positionally corresponding to the periphery of the coupling hole 204 is disposed on the second surface 202 of the installation element, and the annular portion 22 is embedded in an opening of another board fixed to the installation element, so as to enhance the positioning function and the fixing function of the installation element.

Unlike a conventional fixing pillar configured to fix a board in place but undesirably protruding out of the carrier board (i.e. a servo device manufacturing problem), the installation element of the present invention holds a carrier board, using a countersink bolt which passes a conical hole and locks a threaded hole penetrating the installation element itself. After locking the threaded hole, the countersink bolt lies flush with the carrier board but does not protrude out of the carrier board as the conventional fixing pillar does. The threaded holes disposed in the installation element provide more threads than the carrier board does for a locking purpose, such that the installation element is firmly locked on the carrier board.

In the prior art, the threaded hole holding a main board and the bolt screwed into the carrier board are coaxially disposed, thus simultaneous movement readily occurs to both; in this regard, the bolt gets loosened readily whenever another bolt locked in the threaded hole is turn and withdrawn. By contrast, as regards the installation element of the present invention, the threaded hole for locking a main board and the threaded hole for locking a carrier board do not share a common axis and thereby are free of the aforesaid known simultaneous movement. Furthermore, a vibration test proves that a non-coaxial design gets loosened less often than a coaxial design does.

Owing to the aforesaid non-coaxial design of the present invention, the coupling hole of the installation element extends from the body. Hence, the length of the coupling hole is greater than the thickness of the body, such that the coupling hole has enough threads for locking the main board. In so doing, the body is made thin, so as to prevent a waste of space inside the servo device.

In short, the installation element of the present invention is highly industrial applicable, because of its advantages, namely firmness, space saving, and elimination of simultaneous movement.

The present invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. An installation element, comprising:
a body having a first surface and an opposing second surface;
a coupling portion extending outward from the first surface;
an installation hole penetrating the body; and
a coupling hole penetrating the body and the coupling portion, wherein an axis of the couple hole parallels that of the installation hole.

2. The installation element as recited in claim 1, wherein the coupling portion is a protruding block.

3. The installation element as recited in claim 2, wherein the protruding block is one of a rectangle and a polygon.

4. The installation element as recited in claim 1, wherein the coupling hole is a threaded hole.

5. The installation element as recited in claim 1, wherein the installation hole is a threaded hole.

6. The installation element as recited in claim 1, wherein the coupling hole and the installation hole are free of being coaxially disposed.

7. The installation element as recited in claim 1, wherein the installation element further comprises an annular portion disposed on the second surface of the body and positionally corresponding to a periphery of the coupling hole.

8. The installation element as recited in claim 1, wherein the first and second surfaces together greatly exceed the installation hole and the coupling hole together in area.

9. The installation element as recited in claim 1, wherein the body is occupied by the installation hole and the coupling hole to a great extent, such that the first and second surfaces together slightly exceed the installation hole and the coupling hole together in area.
